(19) United States
(12) Patent Application Publication
(10) Pub. No.: US 2023/0059702 A1
(43) Pub. Date: Feb. 23, 2023

(54) REAL ESTATE FIT AND BUDGETING TOOL AND METHOD THEREOF

(71) Applicant: Jones Lang LaSalle IP, Inc., Chicago, IL (US)

(72) Inventors: Kirti Thakkar, Schaumburg, IL (US); Catherine Pawelek, Chicago, IL (US); Saad Abbasi, Aligarh (IN); Sanjay Patel, Carol Stream, IL (US); Santhosh Gadamshetty Sathyanarayana, Bangalore (IN); Paulette Saunders, St. Charles, IL (US)

(21) Appl. No.: 17/881,320

(22) Filed: Aug. 4, 2022

Related U.S. Application Data
(63) Continuation-in-part of application No. 16/299,959, filed on Mar. 12, 2019.
(60) Provisional application No. 62/643,552, filed on Mar. 15, 2018.

(51) Int. Cl. G06Q 50/16; G06Q 30/06

(52) U.S. Cl. CPC G06Q 50/163; G06Q 30/0645; G06Q 50/165

(57) ABSTRACT

A system comprising programmed instructions stored in memory and one or more processors configured to provide remote access to a client over a network to receive real estate space and budgeting estimate in real time through a graphical user interface (GUI). A plurality of test fit parameters are transmitted for display in the GUI for the client device to select. The selected test fit parameters are received wherein at least one comprises usable square footage. The selected property record of a property including property parameters is received. Leasing cost and construction cost estimates and a proposed layout are automatically generated including a determination of a headcount and numbers and types of office space based on the selected test fit parameters including the usable square footage and the selected property record. The generated leasing and construction cost estimates and proposed layout are transmitted for display.

This application is a continuation-in-part of U.S. patent application Ser. No. 16/299,959, filed Mar. 12, 2019, which claims the benefit of U.S. Provisional Patent Application No. 62/643,552, filed Mar. 15, 2018, which are hereby incorporated by reference in their entirety.

### FIELD

This disclosure is generally directed to software tools for real estate applications and, more specifically, to a method and software tool for estimating space and budgeting requirements for real estate applications.

### BACKGROUND

Real estate brokerages compete to provide faster, more accurate estimates for their clients to select properties for leasing/purchasing. Many factors affect the cost to a particular client for a particular property. A tool is needed to help brokers provide fast, accurate estimates and visualizations for clients to compare properties under consideration.

### SUMMARY

A system for estimating space and budgeting requirements for real estate applications comprising memory comprising programmed instructions stored thereon and one or more processors configured to provide remote access to a client device over a network to receive real estate space and budgeting estimate in real time through a graphical user interface. A plurality of test fit parameters are transmitted for display in the graphical user interface for the client device to select. The selected test fit parameters are received, via the graphical user interface, wherein at least one of the selected test fit parameters comprises usable square footage. The selected property record of a subject property including property parameters is received, via the graphical user interface. A leasing cost estimate and a construction cost estimate are automatically generated including a determination of a headcount and numbers and types of office space based on the selected test fit parameters including the usable square footage and the selected subject property record. A proposed layout of a floor plan is automatically generated based on the selected test fit parameters including the usable square footage and the selected subject property record. The generated leasing cost estimate, the generated construction cost estimate, and the generated proposed layout of the floor plan are transmitted for display in the graphical user interface.

A non-transitory computer readable medium having stored thereon instructions comprising executable code that, when executed by one or more processors, causes the one or more processors to receive real estate space and budgeting estimate in real time through a graphical user interface. A plurality of test fit parameters are transmitted for display in the graphical user interface for the client device to select. The selected test fit parameters are received, via the graphical user interface, wherein at least one of the selected test fit parameters comprises usable square footage. The selected property record of a subject property including property parameters is received, via the graphical user interface. A leasing cost estimate and a construction cost estimate are automatically generated including a determination of a headcount and numbers and types of office space based on the selected test fit parameters including the usable square footage and the selected subject property record. A proposed layout of a floor plan is automatically generated based on the selected test fit parameters including the usable square footage and the selected subject property record. The generated leasing cost estimate, the generated construction cost estimate, and the generated proposed layout of the floor plan are transmitted for display in the graphical user interface.

A method for estimating space and budgeting requirements for real estate applications, method comprising steps to receive real estate space and budgeting estimate in real time through a graphical user interface. A plurality of test fit parameters are transmitted for display in the graphical user interface for the client device to select. The selected test fit parameters are received, via the graphical user interface, wherein at least one of the selected test fit parameters comprises usable square footage. The selected property record of a subject property including property parameters is received, via the graphical user interface. A leasing cost estimate and a construction cost estimate are automatically generated including a determination of a headcount and numbers and types of office space based on the selected test fit parameters including the usable square footage and the selected subject property record. A proposed layout of a floor plan is automatically generated based on the selected test fit parameters including the usable square footage and the selected subject property record. The generated leasing cost estimate, the generated construction cost estimate, and the generated proposed layout of the floor plan are transmitted for display in the graphical user interface.

### BRIEF DESCRIPTION OF THE DRAWINGS

FIG. 1 is a block diagram of a computing device for use with the disclosure illustrating the relationship between functional components, in accordance with an example in the present disclosure.

FIG. 2A is a flow chart illustrating one example of method steps executed in accordance with an example in the present disclosure.

FIG. 2B is a flow chart illustrating another example of method steps executed in accordance with another example in the present disclosure.

FIG. 3A is a block diagram illustrating an example of test-fit parameters in accordance with an example in the present disclosure.

FIG. 3B is a block diagram illustrating another example of test-fit parameters in accordance with another example in the present disclosure.

FIG. 4 is a block diagram illustrating an example of property record parameters in accordance with an example in the present disclosure.

FIG. 5 is a screenshot of an example of a user interface for selecting test-fit parameters related to property requirements in accordance with an example in the present disclosure.

FIG. 6 is an example construction cost estimate generated by the estimating tool in accordance with an example in the present disclosure.

FIG. 7 is an example illustration of a test-fit floor plan displayed by the test-fit and budgeting tool in accordance with an example in the present disclosure.

FIG. 8 is a screenshot of another example of a user interface for selecting test-fit parameters related to property requirements in accordance with another example in the present disclosure.

FIG. 9 is a screenshot of an example of a user interface for displaying three different generated estimates for modern or moderate, progressive, and traditional office styles for the same property record.

### DETAILED DESCRIPTION

To facilitate an understanding of the principals and features of the disclosed technology, illustrative examples are explained below. The components described hereinafter as making up various elements of examples of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

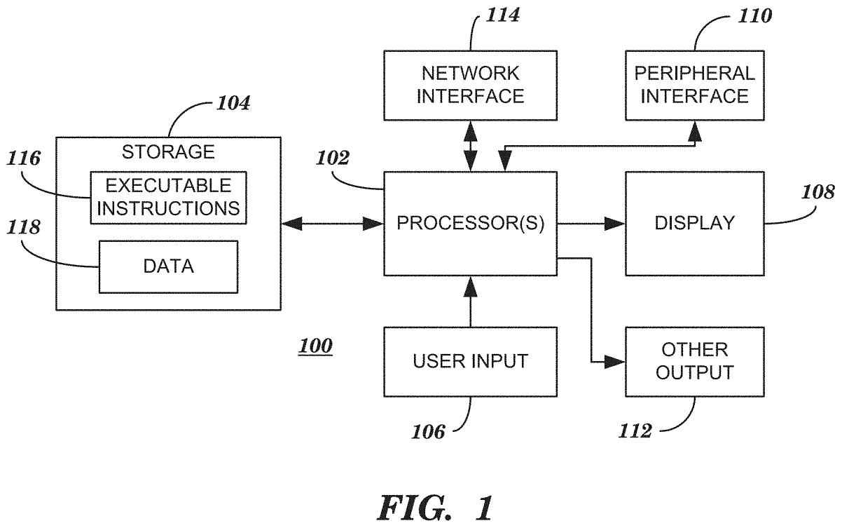

Referring now to the Figures, in which like reference numerals represent like parts, various examples of the computing devices and methods will be disclosed in detail. FIG. 1 is a block diagram illustrating one example of a computing device 100 suitable for use in generating visually integrated real estate data.

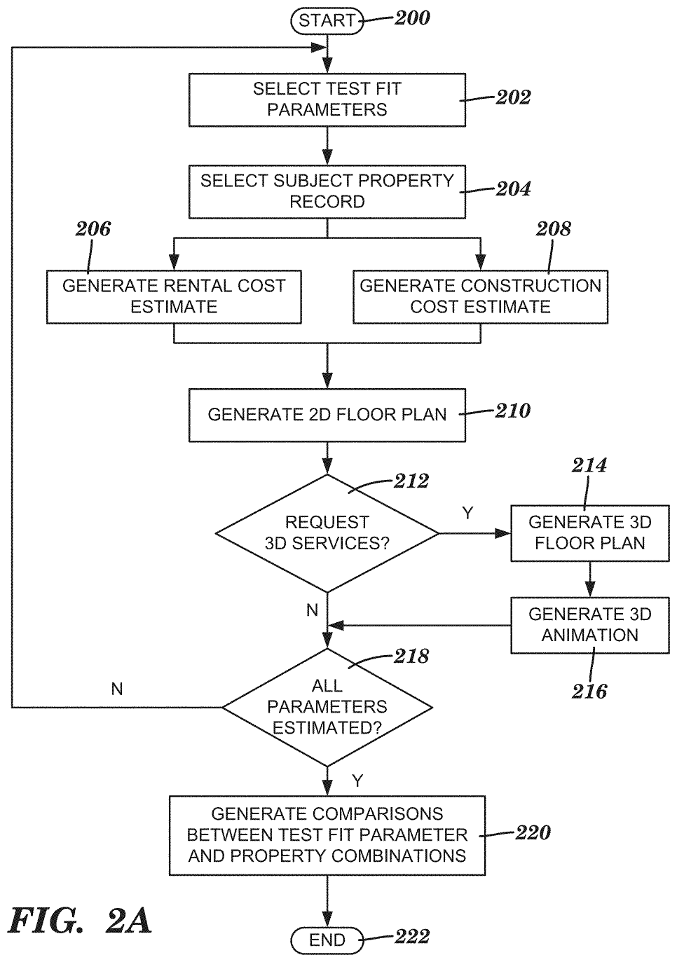

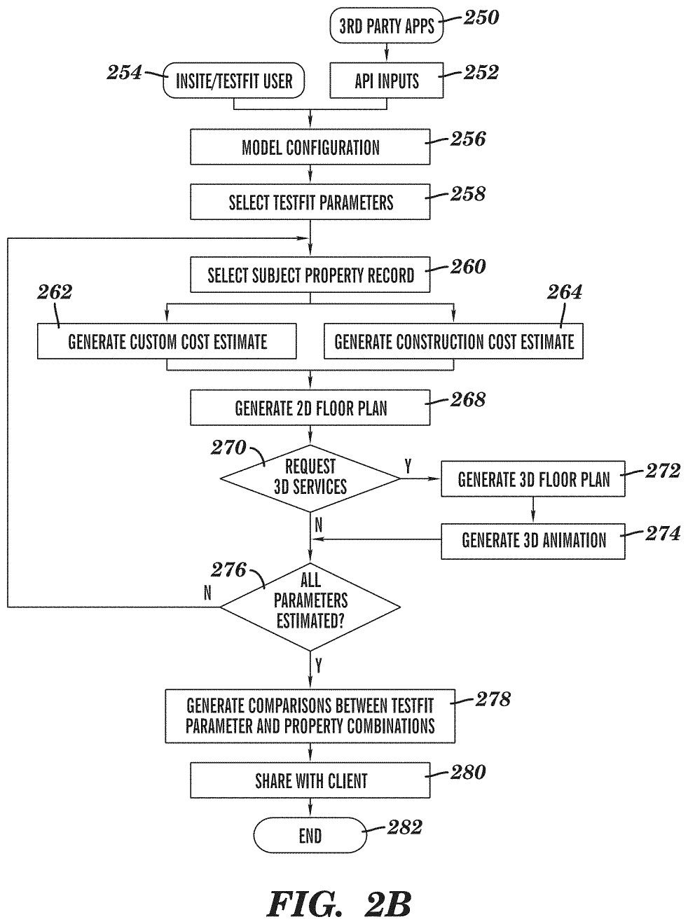

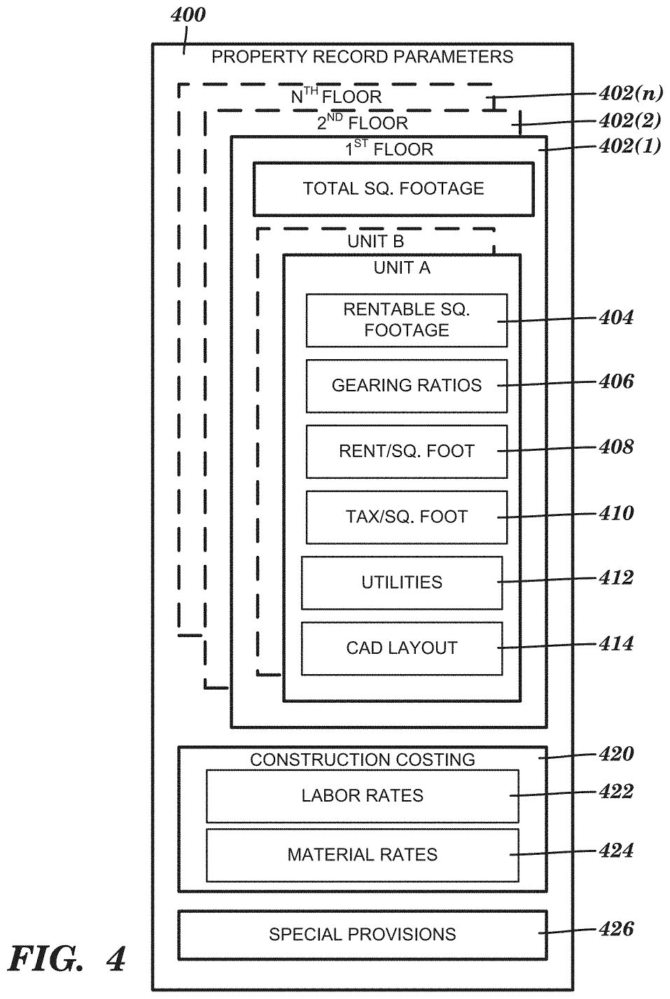

FIG. 1 illustrates a representative computing device 100 that may be used to implement the teachings of the instant disclosure. The computing device 100 may be used to implement, for example, one or more components of the system shown in FIG. 4, as described in greater detail below. As another example, the computing device 100 may be used to implement the methods as described in greater detail below including in FIG. 2.

In this example, the computing device 100 includes one or more processors 102 operatively connected to a storage component 104 which, in turn, includes stored executable instructions 116 and data 118, although the device can have other elements and/or other components in other configurations and store other information. In an example, the processor(s) 102 may include one or more of a microprocessor, microcontroller, digital signal processor, co-processor or the like or combinations thereof capable of executing the stored instructions 116 and operating upon the stored data 118. Likewise, the storage component 104 may include one or more devices, such as volatile or nonvolatile memory including but not limited to random access memory (RAM) or read only memory (ROM). Further still, the storage component 104 may be embodied in a variety of forms, such as a hard drive, optical disc drive, floppy disc drive, flash memory, etc. Processor and storage arrangements of the types illustrated in FIG. 1 are well known to those having ordinary skill in the art. In one example, the processing techniques described herein are implemented as a combination of executable instructions and data within the storage component 104.

As shown, the computing device 100 may also include, by way of example, one or more user input devices 106, a display 108, a peripheral interface 110, other output devices 112, and a network interface 114 in communication with the processor(s) 102. The user input device 106 may include any mechanism for providing user input to the processor(s) 102. For example, the user input device 106 may include a keyboard, a mouse, a touch screen, microphone and suitable voice recognition application, or any other means whereby a user of the device 100 may provide input data to the processor(s) 102. The display 108 may include any conventional display mechanism such as a cathode ray tube (CRT), flat panel display, projector, or any other display mechanism known to those having ordinary skill in the art. In an example, the display 108, in conjunction with suitable stored instructions 116, may be used to implement a graphical user interface. Implementation of a graphical user interface in this manner is well known to those having ordinary skill in the art. The peripheral interface 110 may include the hardware, firmware and/or software necessary for communication with various peripheral devices, such as media drives (e.g., magnetic disk, solid state, or optical disk drives), other processing devices, or any other input source used in connection with the instant techniques. For example, the peripheral interface may be a Universal Serial Bus (USB). Likewise, the other output device(s) 112 may optionally include similar media drive mechanisms, other processing devices, or other output destinations capable of providing information to a user of the device 100, such as speakers, LEDs, tactile outputs, etc. Finally, the network interface 114 may include hardware, firmware, and/or software that allows the processor(s) 102 to communicate with other devices via wired or wireless networks, whether local or wide area, private or public, as known in the art. For example, such networks may include the World Wide Web or Internet, or private enterprise networks, as known in the art.

While the computing device 100 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the computing device 100 may include a greater or lesser number of components than those illustrated. Once again, those of ordinary skill in the art will appreciate the wide number of variations that may be used is this manner. Further still, although a single computing device 100 is illustrated in FIG. 1, it is understood that a combination of such computing devices may be configured to operate in conjunction (for example, using known networking techniques) to implement the teachings of the instant disclosure.

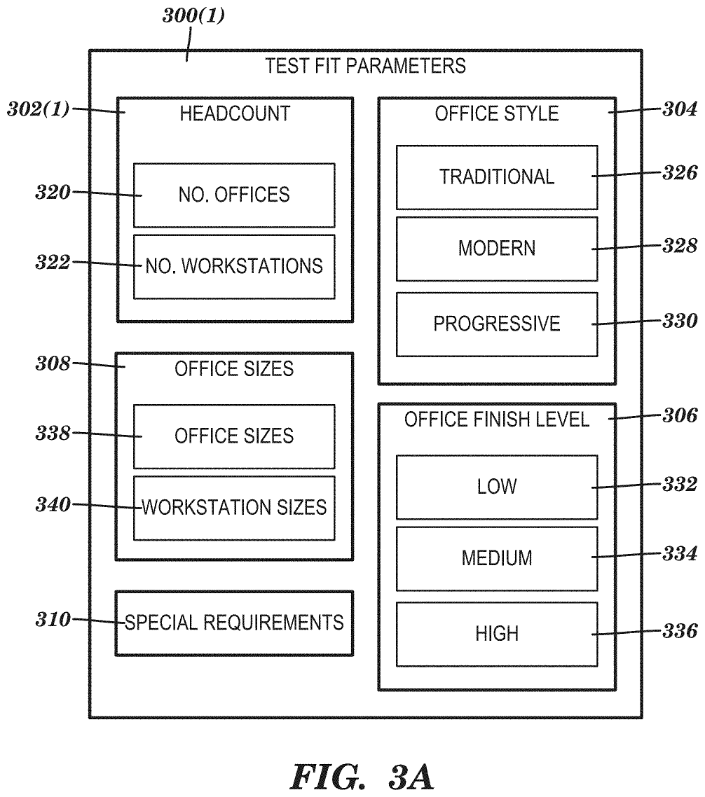

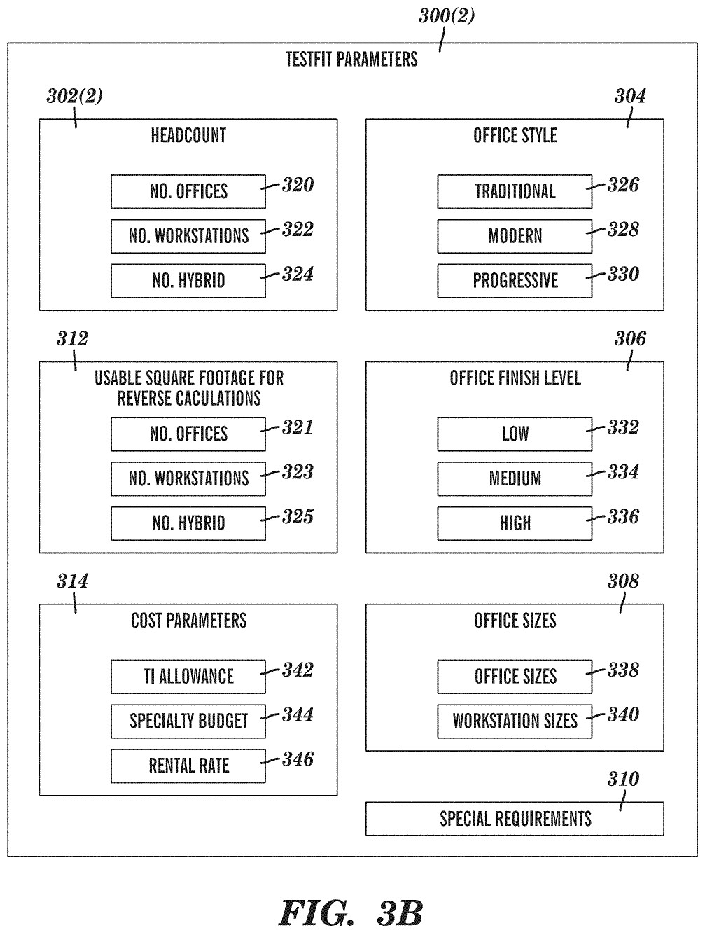

Referring to FIG. 2A, a flow chart of steps in one example of a real estate fit and budgeting method are illustrated. In this example, the method starts in step 200 and then proceeds to step 202 where the computing device 100 receives a user selection of types and/or numbers of number of test fit parameters, such as the exemplary test fit parameters 300(1) shown in FIG. 3A or the exemplary test fit parameters 300(2) shown in FIG. 3B, as discussed in greater detail below, based on a client's needs for a particular application.

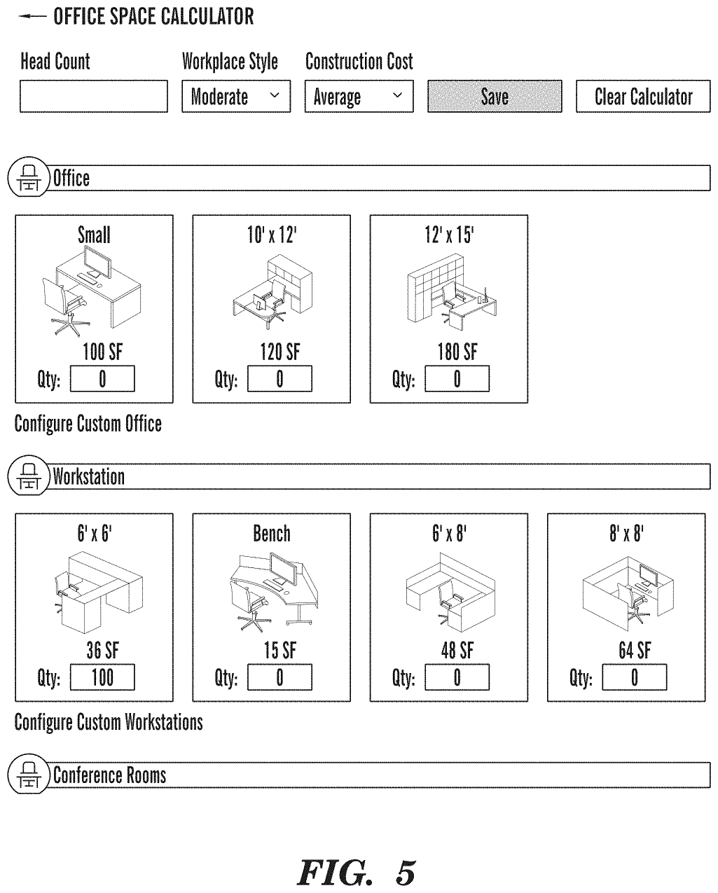

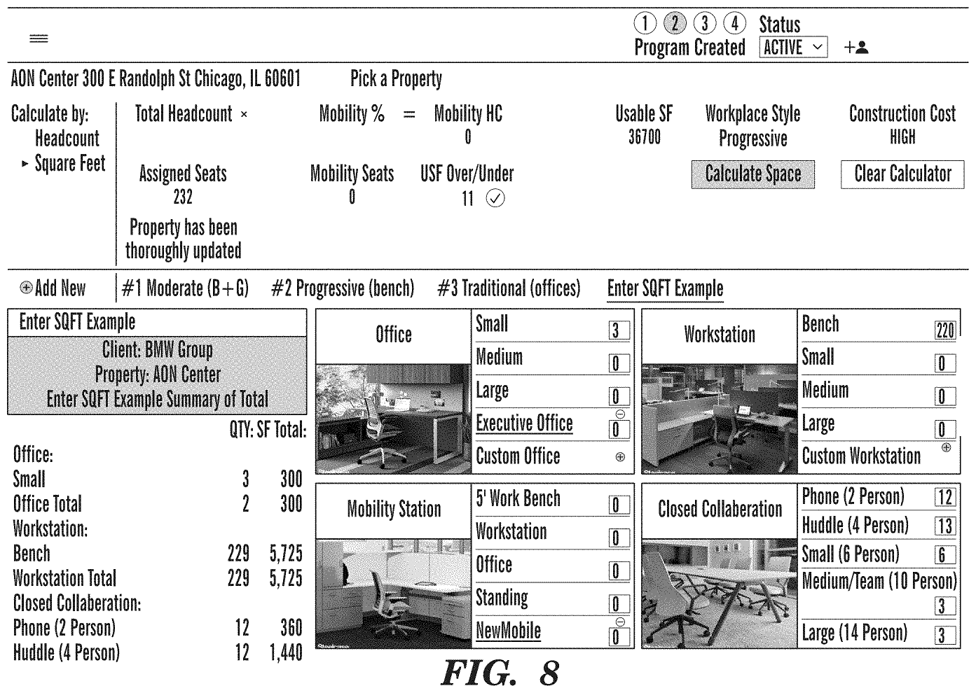

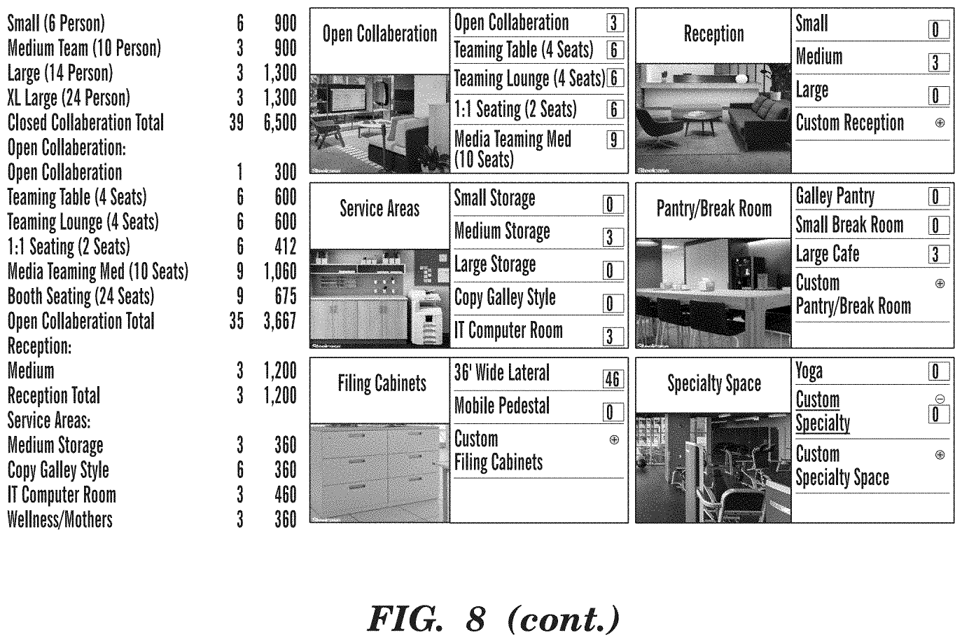

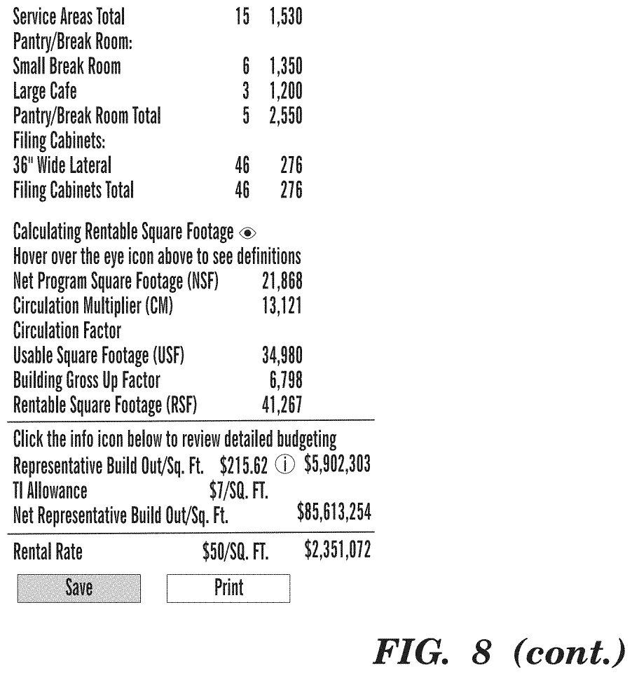

In this example, the selected ones of the test fit parameters 300(1) or 300(2) will be used in conjunction with a property record 400 to generate a test fit and budget for the client's application in relation to a particular property. One example of a user interface on display 108 of the computing device 100 which may be used to select particular ones of the test fit parameters 300(1) or 300(2) with user input 106 is illustrated in FIG. 5. Another example of a user interface on display 108 of the computing device 100 which may be used to select particular ones of the test fit parameters 300(1) or 300(2) with user input 106 is illustrated in FIG. 8. As illustrated in these examples, a variety of different types of parameters can be selected and combined to generate of different dynamic estimates. For example as shown in FIG. 8, the computing device 100 when generating these estimates can take into via user input account actual usable square footage, along with office style 304 (also referred to as workplace style), cost parameters 314 (also referred to as construction costs) which can also take into account other costs, such as a tenant allowance 342, a specialty budget 344, and/or a rental rate 346, office sizes 306 and office finish levels 306 for different parts and aspects, such as offices, workstations, mobility stations, closed collaboration spaces, open collaboration spaces, reception areas, service areas, family/break rooms, filing cabinets or other storage areas, and/or specialty space and then determine, for examples, a headcount and workstation numbers. Further, in some examples, a client at the computing device 100 may select to apply a particular set of selected test-fit parameters to multiple properties or may select to apply multiple sets of selected test-fit parameters to a particular property, or both to generate estimates and/or 2D or 3D layouts and/or animations.

Referring to FIG. 3A, an exemplary set of test fit parameters 300(1) which can be selected is illustrated, although other sets of test fit parameters can be used, such as test fit parameters 300(2) shown in FIG. 3B by way of example. The selected ones of the test fit parameters 300(1) define a client's needs for a particular application. In this example, the test fit parameters 300(1) are divided into parameters for headcount 302(1), office style 304, office finish levels 306, office sizes 308, and special requirements 310, although other types and/or numbers of test fit parameters could be used, such as the test fit parameters 300(2) which are divided into parameters for headcount 302(2), office style 304, office finish levels 306, office sizes 308, special requirements 310, usable square footage for reverse calculations 312, and cost parameters 314 as illustrated and described herein with reference to FIG. 3B.

In this example, the parameter for headcount 302(1) defines the number of workers the client needs to accommodate in the proposed application and may further comprise additional parameters for a number of total offices 320 and a number and/or types of total workstations 322 each based on the headcount 302(1), although the headcount 302(1) may include other aspects, such as a number of hybrid office spaces 324 as shown in headcount 302(2) in FIG. 3B by way of example only and may be based on other factors, such as anticipated growth rates or numbers. The types of workstations 322 in headcount 302(1) may comprise enclosed offices and cubicles by way of example only, although other types of workstations may be used. Additionally, the types of workstations 322 in headcount 302(1) may also include one or more specialized types of workstations, such as a reception area workstation by way of example, although other types and/or numbers of other specialized workstations can be selected or configured by the user of the computing device 100. Each of these types of workstations 322 may comprise instructions for particular stored design dimensions and configurations.

Test fit parameters 300(1) for headcount 302(1) and the office style 304 may also in some examples be specified cooperatively. For example, a client may specify for headcount 302(1) comprising parameters for a total headcount and a total number of work stations 322 which could differ, e.g. the number of workstations may be set to accommodate anticipated growth. In this example, the client may further specify under the test fit parameter for headcount 302(1) another parameter for a minimum number of the total number of workstations 322 to require a particular type of workstation, such as an enclosed office type, with the remainder of the total number of workstations 322 being automatically allocated into types of workstations based on a selection of the parameter for office style 304 as described below.

In this example, the parameter for office style 304 comprises options for traditional office style 326, modern office style 328, or progressive office style 330 each of which has associated executable rules on how densely the subject property will be used by the client's application, although other types of styles with other executable rules may be used. By way of example, the stored executable rules for designing a layout of a traditional office style 326 may include a higher ratio of single-user workstations (e.g. enclosed offices and cubicles) to common space, although the executable rules may address other aspects associated with a traditional office style 326. The stored executable rules for designing a layout of a modern office style 328 may be in-between the traditional and progressive styles in terms of application density), although the executable rules may address other aspects associated with a modern office style 328. The stored executable rules for designing a layout of a progressive office style 330 may include a lower ratio of single-user workstations in favor of more common space (e.g. workbenches, common areas, conference/collaboration rooms), although the executable rules may address other aspects associated with a progressive office style 330. In this example, a progressive office style 330 would require fewer square feet per worker (greater application density), potentially saving the client money on leasing and construction expense in exchange for a less-formal office space. For this reason, 2D and 3D CAD layouts and walk-throughs of each of the workstations generated and provided with the cost estimates to the client device 100 help the client to weigh costs versus the layout and atmosphere desired for the client's particular application. Although the above example uses “office” styles, other examples could apply styles to any real estate applications, for example: manufacturing, warehousing, retail locations, professional/medical offices, etc. Additionally, in some examples the computing device 100 may adjust one or more other selected parameters, such as office sizes and/or types, based on and to fit within, for example, the usable square footage and the selected office style 304.

In this example, the parameter for office finish level 306 includes a low office finish 332, a medium office finish 334, and a high office finish 336, although the office finish level 306 may include other finishes. In this example, the office finish level 306 is further broken down into a low office finish level 332, a medium office finish level 334, and a high office finish level 336, although other types and/or number of office finish levels could be used. Each of the low office finish level 332, the medium office finish level 334, and the high office finish level 336 include different stored data and executable design rules with the low office finish level 332 having the least amount of options and/or least expensive options for materials and other goods to design the application with, the high office finish level 336 having the greatest amount of options and/or most expensive options for materials and other goods to design the application with, with the medium office finish level 334 falling between the low office finish level 332 and the high office finish level 336 in this particular example.

In this example, the parameter for office sizes 308 comprises parameters particular office sizes 338 and workstation sizes 340, although the office sizes 308 may include other sizes and/or types of configurations. In this example, the particular office sizes 338 and workstation sizes 340 comprise data and executable design rules which correspond with the selected on of the traditional office style 326, the modern office style 328, or the progressive office style 330.

In some examples, the test fit parameters may also define a parameter for special requirements 310, although other types of test fit parameters may be used. In this example the parameter for special requirements 310 may comprise data and/or executable design rules for parts of the design, such as particular special requirements for kitchens, conference rooms, or storage areas by way of example only.

Referring to FIG. 3B, another exemplary set of test fit parameters 300(2) which can be selected is illustrated. The exemplary set of test fit parameters 300(2) are the same as the exemplary set of test fit parameters 300(1), except as otherwise illustrated or described by way of the examples herein.

In this example, the exemplary set of test fit parameters 300(2) also include as an additional parameter the usable square footage 312 for reverse calculations which includes parameters for the number of offices 321, the number of workstations 323, and the number of hybrid workstations 325 each based on the usable square footage for reverse calculations 312, although other types and/or numbers of other parameters related to usable square footage can be used. With the usable square footage 312, the computing device 100 can execute programmed instructions for reverse calculations to determine, for example, headcount 302(2) including number of offices 320, number of work stations 322, and number of hybrid or other spaces 324 as well as office sizes 308, although other types of test fit parameters can be determined in reverse. The computing device 100 may receive or automatically determine the usable square footage 312 from an analysis of a layout of the total square footage from the property record 400. For example, older properties may have larger total square footage than usable square footage because of their architectural design which can impact the generated estimates and layout. Accordingly, with examples of this technology the computing device 100 is able to utilize the actual usable square footage as well as the layout of that actual square footage as parameters with other selected parameters, such as office style 304, to generate exemplary estimates and/or 2D and/or 3D layouts and/or animations to provide a client a real time perspective of the property in different possible configurations along with illustrating any possible restrictions the layout may pose. Further, as shown in FIG. 8 with the usable square footage and selected office style, the generated estimate calculates and provides a comprehensive output of the selected design(s) for the application for the property by way of example.

In this example, the exemplary set of test fit parameters 300(2) also includes an additional parameter for various possible cost parameters 314, such as parameters for a tenant allowance 342, a specialty budget 344, and/or a rental rate 346 which can be factored into portions or all of the generated estimates, although other types and/or numbers of other parameters related to cost can be used. Accordingly in examples of this technology the computing device 100 can also take into account and incorporate not only overall construction costs, but may also factor in other cost parameters 314, such as tenant allowance 342 for particular requested modifications or updates on a set time period, a specialty budget 344 for unique design requests, and/or a lease or rental rate 346 for all or parts of the property to provide dynamic feedback on possible return for a lease or rental.

Referring back to FIG. 2A, in step 204, the computing device 100 receives a user selection of a subject property record, such as the exemplary subject property record 400 as illustrated in FIG. 4. In FIG. 4, the exemplary property record 400 defines parameters that may limit applications (e.g. available space) and affect client leasing and construction costs for a particular property. Additionally, as illustrated in this example the exemplary property record 400 may be sub-divided, in which case a property sub-record would exist for each current subdivision (e.g. floor—1^{st} floor 402(1), 2^{nd} floor 402(2), . . . Nth floor 402(n)) of a property. In this example, each floor 402(1)-402(n) of the property record 400 may further each comprise its own particular parameters relating to rentable square footage 404, gearing ratios 406 (e.g. ratios of useable space to total space, facilities requirements per square foot, etc.), rent per square foot 408, tax per square foot, estimated utilities cost 412 (either per unit or per square foot in this example), and CAD layout 414 of the available unit, although other types and/or numbers of other parameters may be used. Further, the exemplary property record 400 may define parameters for construction costs 420 which may include additional parameters for labor rates 422 and materials rates 422 and for special provisions 426 relating to construction costs 420, such as building common areas and separate from special requirements 310, although exemplary property record 400 may have other types and/or numbers of other parameters. In this example, the construction costs 420 and special provisions 426 apply to an entire property, for example local labor and material rates for construction projects. In particular, in examples of this technology the computing device 100 can adjust the generated estimates and layout to take into account gearing ratios 406 (e.g. ratios of useable space to total space, facilities requirements per square foot, etc.)

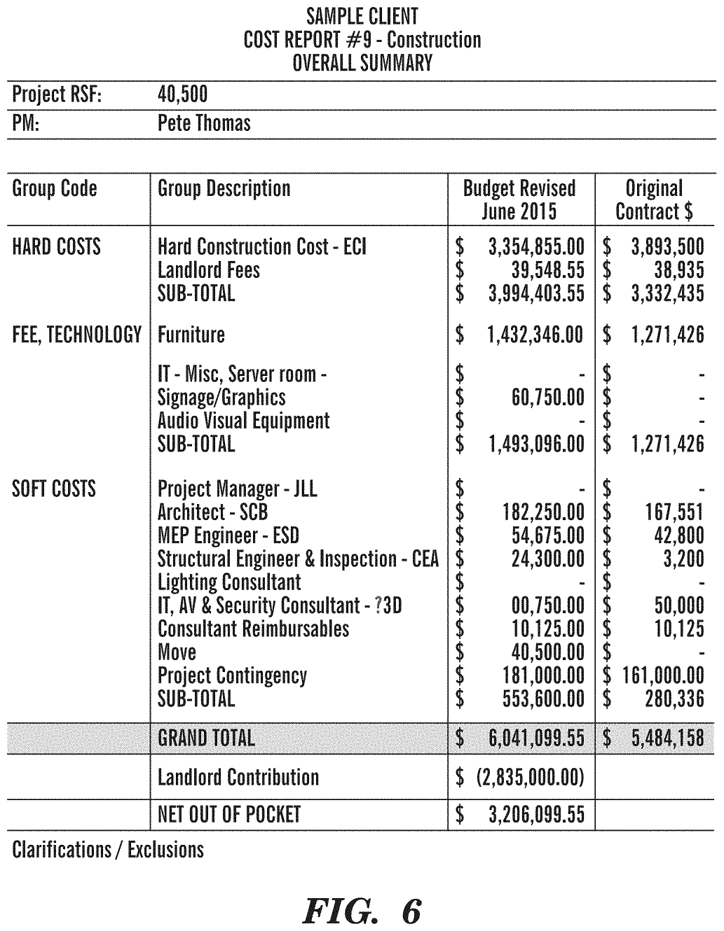

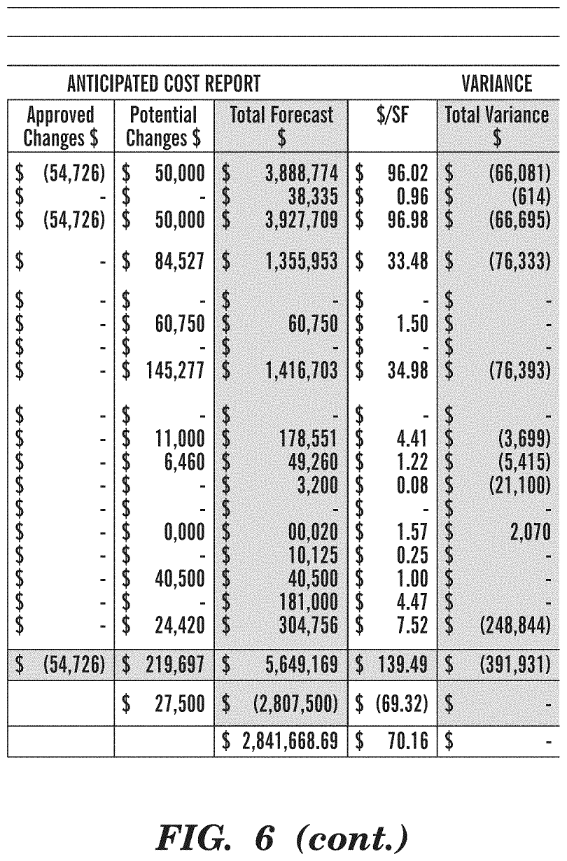

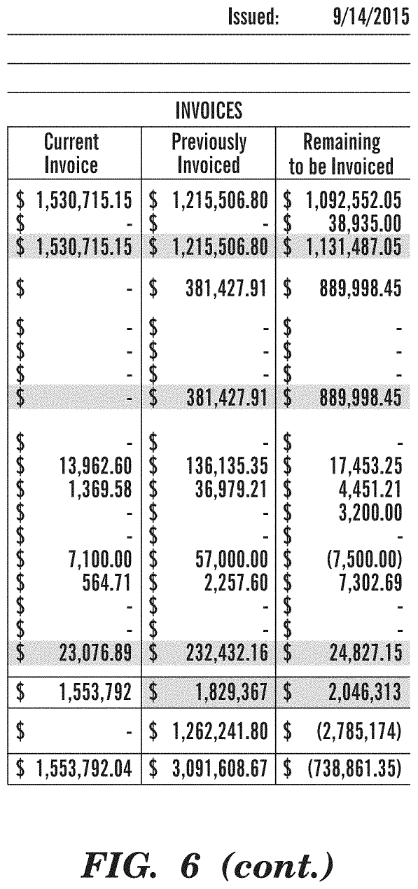

Referring back to FIG. 2A, in steps 206 and 208 the computing device 100 generates a leasing or rental cost estimate and a construction cost estimate based on executable property design rules which take into account the selected ones of the test fit parameters and the parameters of the selected one of the property records. An example of a generated construction budget estimate is shown in FIG. 6 and multiple generated construction estimates for modern or moderate, progressive and traditional office styles for the same property record provided in a comparison format are shown in FIG. 8. These estimates shown in the example in FIG. 8 may be generated by the computing device 100 independently or sequentially.

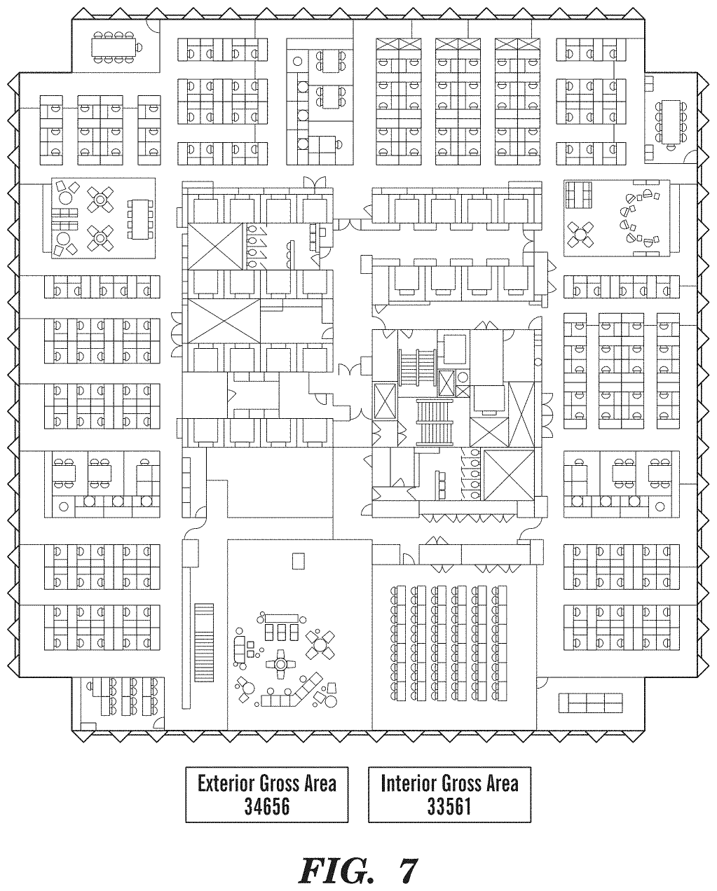

In step 210, the computing device 100 may generate in real time a two-dimensional (2D) Computer-Assisted Drafting (CAD) floor plan illustrating a proposed layout for the selected test fit parameters within the subject property for the property record 400, although other types of plans may be generate. An exemplary generated a two-dimensional (2D) Computer-Assisted Drafting (CAD) floor plan is illustrated in FIG. 7.

In step 212, the computing device 100 may determine when a request for generation of a three-dimensional (3D) services for 3D representations has been received. If in step 212 the computing device determines that a request for generation of a three-dimensional (3D) services for 3D representations has been received, then a Yes branch is taken to step 214.

In step 214, the computing device 100 may generate in real time a 3D floor plan of a layout for all or part of the generated estimate for the selected property record 400, such as for each floor or for particular floors.

In step 216, the computing device 100 may further generate in real time a 3D animation to illustrate aspects of the generate a 3D floor plan or layout for all or part of the generated estimate for the selected property record 400. For example, a client may request with the computing device 100 a 3D animation of a “walk-though,” i.e., a first-person view that a client would experience as walking through the finished space.

If back in step 212 the computing device 100 determines that a request for generation of a three-dimensional (3D) services for 3D representations has not been received, then a No branch is taken to step 218. In step 218, the computing device 100 determines when all of the selected parameters have been incorporated into the generated estimates and any generated layouts. If in step 218 the computing device 100 determines that any of the selected parameters have not been taken into account or a new parameter has been entered, then the No branch is taken back to step 202 as described earlier where the selected parameters not taken into account before can be incorporated.

If in step 218 the computing device 100 determines all of the selected parameters have been taken into account, then the Yes branch is taken back to step 220. In step 220 the computing device 100 may generate comparisons between various combination of selected parameters for the property record 400, although other types and/or numbers of displays may be generated.

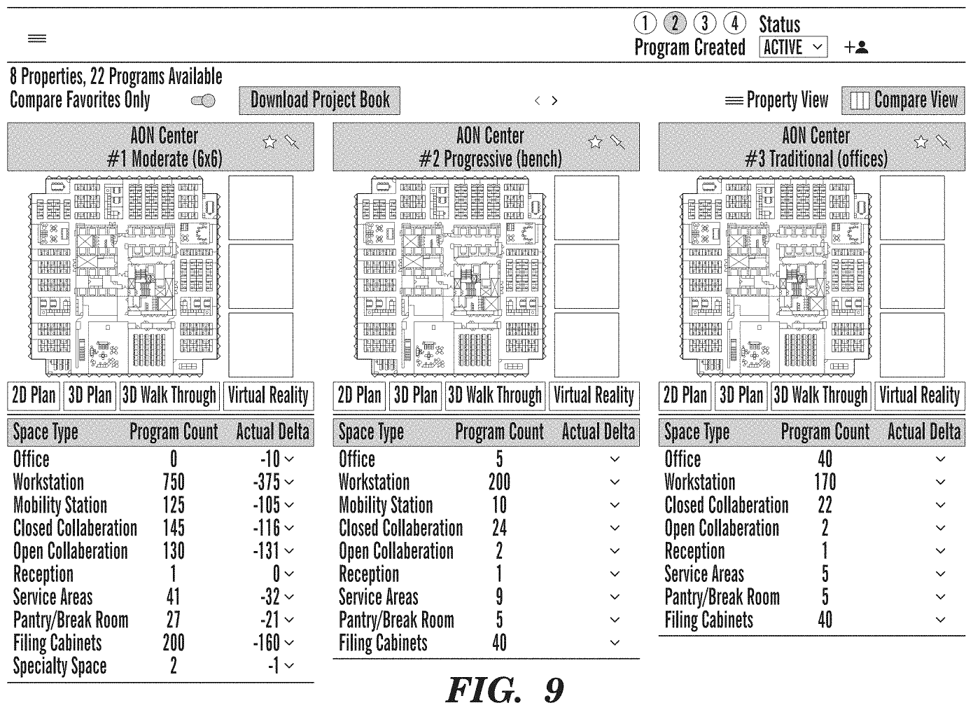

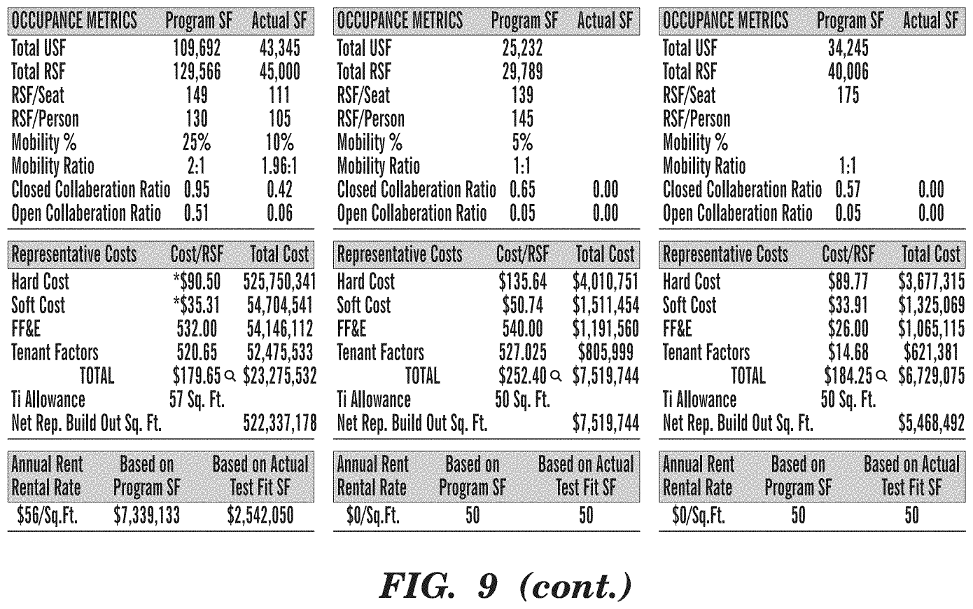

For example, generated leasing estimates may be displayed side-by side. In another example, generated construction estimates may be displayed side-by-side. In another example, three different generated estimates for modern or moderate, progressive, and traditional office styles for the same property record 400 may be displayed side-by-side as illustrated in FIG. 9. In yet another example, a combination of generated leasing estimates, construction estimates, and floor plans may be displayed. In a further, a user of the computing device 100 can select using a user-input 106 a generated estimate or a generated floor plan which comprises an initial level of information and request and then may request and receive a more detailed version of that generated estimate or floor plan which can be generated and displayed in real time, such as an initial pricing and 2D layout view and then a 3D layout and/or 3D animation walk through view may be generated and provided. Accordingly, examples of this technology can in real time provide various levels of detailed generated estimates and layouts including 3D layouts as well as real time animations to provide enhanced visualization of each possible design. If additional estimates are required, then this exemplary process may start-over, otherwise in step 222 this example of the method may end.

Referring to FIG. 2B, a flow chart of steps in another example of a real estate fit and budgeting method are illustrated. The exemplary method illustrated in FIG. 2B is the same as the exemplary one in FIG. 2A, except as illustrated and described herein.

In this example, the method starts in step 250 and then proceeds to step 252 where the computing device 100 receives one or more inputs from a third party user, which contain, a user selection of types and/or numbers of number of test fit parameters, such as the exemplary test fit parameters 300(1) shown in FIG. 3A or the exemplary test fit parameters 300(2) shown in FIG. 3B, as discussed in greater detail below, based on a client's needs for a particular application.

In step 252, the computing device 100 may also initiate one or more APIs to integrate with one or more third party applications which may be selected by the third party user of the computing device 100, although other manners for initiating APIs and/or identifying applications could be used, such as based the types and/or numbers test fit parameters, such as the exemplary test fit parameters 300(1) shown in FIG. 3A or the exemplary test fit parameters 300(2) shown in FIG. 3B, as discussed in greater detail below, which are selected or otherwise obtained based on a client's needs for a particular application.

In step 254, the computing device 100 may also initiate executable instructions to perform a reverse calculation of the usable square footage for a particular selected property record or records. By way of example, the computing device 100 may be able to analyze and calculate usable square footage from total square footage based on information in the selected property record and one or more other selected parameters, such as office style which may include types and sizes of workstations. Accordingly, a client may desire a progressive office style parameter, but with the unique layout of one or more floors of the selected property record, would be able to have estimates generated for a progressive office style parameter and a modern office style parameter, and be provided with a generated estimate and/or visualization with 2D or 3D layouts and/or animation that illustrate the estimate for a modern office style parameter may be a more advantageous layout.

In step 256 the computing device 100 may identify any particular stored or otherwise input model configurations for the requesting client, such as particular size and space standards for different parameters, e.g. particular dimension or minimum and/or maximum dimensions, and one or more cost benchmarks for different parameters, such as minimum and/or maximum cost allowances, by way of example only. The obtained model configurations may be incorporated into generation of the one or more estimates.

In step 258 the computing device 100 receives a user selection of types and/or numbers of number of test fit parameters, such as the exemplary test fit parameters 300(1) shown in FIG. 3A or the exemplary test fit parameters 300(2) shown in FIG. 3B, as discussed in greater detail below, based on a client's needs for a particular application. In this example, the selected ones of the test fit parameters 300(1) or 300(2) will be used in conjunction with a property record 400 to generate a test fit and budget for the client's application in relation to a particular property. One example of a user interface on display 108 of the computing device 100 which may be used to select particular ones of the test fit parameters 300(1) or 300(2) with user input 106 is illustrated in FIG. 5. Another example of a user interface on display 108 of the computing device 100 which may be used to select particular ones of the test fit parameters 300(1) or 300(2) with user input 106 is illustrated in FIG. 8. As illustrated in these examples, a variety of different types of parameters can be selected and combined to generate dynamic estimates.

In step 260, the computing device 100 receives a user selection of a subject property record, such as the exemplary subject property record 400 as illustrated in FIG. 4 and discussed in greater detail below.

In steps 262 and 264 the computing device 100 generates a leasing or rental cost estimate and a construction cost estimate based on the selected ones of the test fit parameters and the parameters of the selected one of the property records. An example of a generated construction budget estimate is shown in FIG. 6 and of multiple generated construction estimates for modern or moderate, progressive and traditional office styles for the same property record is shown in FIG. 8. These estimates may be generated by the computing device 100 independently or sequentially. As shown in FIG. 8, examples of this technology also allow user input to manually override generated estimates based on selected test fit parameters, such as the manual adjustment of assigned numbers of seats, which may alter one or more other aspects of the generated estimates and layout and is noted in the display.

In step 268, the computing device 100 may generate a two-dimensional (2D) Computer-Assisted Drafting (CAD) floor plan illustrating a proposed layout for the selected test fit parameters within the subject property for the property record 400. An exemplary generated a two-dimensional (2D) Computer-Assisted Drafting (CAD) floor plan is illustrated in FIG. 7.

In step 270, the computing device 100 may determine when a request for generation of a three-dimensional (3D) services for 3D representations has been received. If in step 270 the computing device 100 determines that a request for generation of a three-dimensional (3D) services for 3D representations has been received, then a Yes branch is taken to step 272.

In step 272, the computing device 100 may generate a 3D floor plan or layout for all or part of the generated estimate for the selected property record 400. In some examples, a client may request three-dimensional (3D) services. For example, a client may request with the computing device 100 a 3D CAD model of the proposed layout.

In step 274, the computing device 100 may further generate 3D animation to illustrate aspects of the generate a 3D floor plan or layout for all or part of the generated estimate for the selected property record 400. For example, a client may request with the computing device 100 a 3D animation of a “walk-though,” i.e., a first-person view that a client would experience walking through the finished space.

If back in step 270 the computing device determines that a request for generation of a three-dimensional (3D) services for 3D representations has not been received, then a No branch is taken to step 276. In step 276, the computing device 100 determines when all of the selected parameters have been incorporated into the generated estimates and any generated layouts. If in step 276 the computing device 100 determines that any of the selected parameters have not been taken into account or a new parameter has been entered, then the No branch is taken back to step 260 as described earlier where the selected parameters not taken into account before can be incorporated.

If in step 276 the computing device 100 determines all of the selected parameters have been taken into account, then the Yes branch is taken back to step 278. In step 278 the computing device 100 may generate comparisons between various combination of selected parameters for the property record 400 and then provide them in step 280 to the user at the computing device 100 in this example, although other types and/or numbers of displays may be generated.

For example, generated leasing estimates may be displayed side-by side. In another example, generated construction estimates including those based on usable square footage and/or particular cost parameters may be displayed side-by-side. In another example, three different generated estimates for modern or moderate, progressive, and traditional office styles for the same property record 400 may be displayed side-by-side as illustrated in FIG. 9. In yet another example, a combination of generated leasing estimates, construction estimates, and floor plans may be displayed. In a further, a user of the computing device 100 can select using a user-input 106 a generated estimate or a generated floor plan which comprises an initial level of information and request and then may request and receive a more detailed version of that generated estimate or floor plan which can be generated and displayed, such as an initial pricing and 2D layout view and then a 3D layout and/or 3D animation walk through view may be generated and provided. Accordingly, examples of this technology can in real time provide various levels of detailed generated estimates and layouts including 3D layouts as well as real time animations to provide enhanced visualization of each possible design. If additional estimates are required, then this exemplary process may start-over, otherwise in step 282 this example of the method may end.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art. For example, one skilled in the art will recognize that executable instructions may be stored on a non-transient, computer-readable storage medium, such that when executed by one or more processors, causes the one or more processors to implement the method described above.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain examples of this technology are described above with reference to block and flow diagrams of computing devices and methods and/or computer program products according to examples of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some examples of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain examples of this disclosure have been described in connection with what is presently considered to be the most practical and various examples, it is to be understood that this disclosure is not to be limited to the disclosed examples, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain examples of the technology and also to enable any person skilled in the art to practice certain examples of this technology, including making and using any apparatuses or systems and performing any incorporated methods. The patentable scope of certain examples of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for estimating space and budgeting requirements for real estate applications comprising memory comprising programmed instructions stored thereon and one or more processors configured to:
provide remote access to a client device over a network to receive real estate space and budgeting estimate in real time through a graphical user interface;
transmit a plurality of test fit parameters for display in the graphical user interface for the client device to select;
receive, via the graphical user interface, the selected test fit parameters, wherein at least one of the selected test fit parameters comprises usable square footage;
receive, via the graphical user interface, the selected property record of a subject property including property parameters;
automatically generate a leasing cost estimate and a construction cost estimate including a determination of a headcount and numbers and types of office space based on the selected test fit parameters including the usable square footage and the selected subject property record;
automatically generate a proposed layout of a floor plan based on the selected test fit parameters including the usable square footage and the selected subject property record; and
transmit the generated leasing cost estimate, the generated construction cost estimate, and the generated proposed layout of the floor plan for display in the graphical user interface.

2. The system of claim 1, wherein the proposed layout of the floor plan includes at least one of the following: a two-dimensional computer-assisted drafting (CAD) floor plan, a three-dimensional CAD floor plan, or a three-dimensional animation of a walk-through of at least a portion of the floor plan.

3. The system of claim 1, wherein the test fit parameters define the one or more specifications for an application of the subject property.

4. The system of claim 3, wherein the selected test fit parameters include at least one of the following information: headcount, office style, office finish levels, the usable square footage, office sizes, cost, and special requirements.

5. The system of claim 4, wherein the office style determines how densely the subject property is used by the user's application.

6. The system of claim 4, wherein the office styles include at least one of the following: traditional, modern or progressive office styles.

7. The system of claim 6, wherein the traditional office style includes a first ratio of single-user workspace to common space, the progressive office style includes a second ratio of single-use workspace to common space, and the modern office style includes a third ratio of single-user work space to common space, wherein the first ratio is greater than the second ratio, and the third ratio falls between the first ratio and the second ratio and wherein the selected test fit parameters for office sizes are adjusted based on the selected one of the office styles.

8. The system of claim 4, wherein the headcount includes at least one of the following: a number of workers or a number of workspaces.

9. The system of claim 1, wherein the parameters of the property record include space available for lease or rent, gearing ratios, leasing or rental cost per square foot, estimated tax expense per square foot, estimated utilities cost, and a CAD layout of each available unit.

10. The system of claim 1, wherein the selected test fit parameters further comprise a tenant allowance cost, a specialty budget cost, or a lease or rental rate cost for part or all of the property, wherein the generated leasing cost estimate and the generated construction cost estimate are adjusted based on the tenant allowance cost, the specialty budget cost, or the lease or rental rate cost for part or all of the property.

11. A non-transitory computer readable medium having stored thereon instructions comprising executable code that, when executed by one or more processors, causes the one or more processors to:
provide remote access to a client device over a network to receive real estate space and budgeting estimate in real time through a graphical user interface;
transmit a plurality of test fit parameters for display in the graphical user interface for the client device to select;
receive, via the graphical user interface, the selected test fit parameters, wherein at least one of the selected test fit parameters comprises usable square footage;
receive, via the graphical user interface, the selected property record of a subject property including property parameters;
automatically generate a leasing cost estimate and a construction cost estimate including a determination of a headcount and numbers and types of office space based on the selected test fit parameters including the usable square footage and the selected subject property record;
automatically generate a proposed layout of a floor plan based on the selected test fit parameters including the usable square footage and the selected subject property record; and
transmit the generated leasing cost estimate, the generated construction cost estimate, and the generated proposed layout of the floor plan for display in the graphical user interface.

12. The non-transitory computer readable medium of claim 11, wherein the proposed layout of the floor plan includes at least one of the following: a two-dimensional computer-assisted drafting (CAD) floor plan, a three-dimensional CAD floor plan, or a three-dimensional animation of a walk-through of at least a portion of the floor plan.

13. The non-transitory computer readable medium of claim 11, wherein the test fit parameters define the one or more specifications for an application of the subject property.

14. The non-transitory computer readable medium of claim 13, wherein the selected test fit parameters include at least one of the following information: headcount, office style, office finish levels, the usable square footage, office sizes, cost, and special requirements.

15. The non-transitory computer readable medium of claim 14, wherein the office style determines how densely the subject property is used by the user's application.

16. The non-transitory computer readable medium of claim 14, wherein the office styles include at least one of the following: traditional, modern or progressive office styles.

17. The non-transitory computer readable medium of claim 16, wherein the traditional office style includes a first ratio of single-user workspace to common space, the progressive office style includes a second ratio of single-use workspace to common space, and the modern office style includes a third ratio of single-user work space to common space, wherein the first ratio is greater than the second ratio, and the third ratio falls between the first ratio and the second ratio and wherein the selected test fit parameters for office sizes are adjusted based on the selected one of the office styles.

18. The non-transitory computer readable medium of claim 14, wherein the headcount includes at least one of the following: a number of workers or a number of workspaces.

19. The non-transitory computer readable medium of claim 11, wherein the parameters of the property record include space available for lease or rent, gearing ratios, leasing or rental cost per square foot, estimated tax expense per square foot, estimated utilities cost, and a CAD layout of each available unit.

20. The non-transitory computer readable medium of claim 11, wherein the selected test fit parameters further comprise a tenant allowance cost, a specialty budget cost, or a lease or rental rate cost for part or all of the property, wherein the generated leasing cost estimate and the generated construction cost estimate are adjusted based on the tenant allowance cost, the specialty budget cost, or the lease or rental rate cost for part or all of the property.

21. A method for estimating space and budgeting requirements for real estate applications, method comprising:
providing remote access to a client device over a network to receive real estate space and budgeting estimate in real time through a graphical user interface;
transmitting a plurality of test fit parameters for display in the graphical user interface for the client device to select;
receiving, via the graphical user interface, the selected test fit parameters, wherein at least one of the selected test fit parameters comprises usable square footage;
receive, via the graphical user interface, the selected property record of a subject property including property parameters;
automatically generating a leasing cost estimate and a construction cost estimate including a determination of a headcount and numbers and types of office space based on the selected test fit parameters including the usable square footage and the selected subject property record;
automatically generating a proposed layout of a floor plan based on the selected test fit parameters including the usable square footage and the selected subject property record; and
transmitting the generated leasing cost estimate, the generated construction cost estimate, and the generated proposed layout of the floor plan for display in the graphical user interface.

22. The non-transitory computer readable medium of claim 21, wherein the proposed layout of the floor plan includes at least one of the following: a two-dimensional computer-assisted drafting (CAD) floor plan, a three-dimensional CAD floor plan, or a three-dimensional animation of a walk-through of at least a portion of the floor plan.

23. The non-transitory computer readable medium of claim 21, wherein the test fit parameters define the one or more specifications for an application of the subject property.

24. The non-transitory computer readable medium of claim 23, wherein the selected test fit parameters include at least one of the following information: headcount, office style, office finish levels, the usable square footage, office sizes, cost, and special requirements.

25. The non-transitory computer readable medium of claim 24, wherein the office style determines how densely the subject property is used by the user's application.

26. The non-transitory computer readable medium of claim 24, wherein the office styles include at least one of the following: traditional, modern or progressive office styles.

27. The non-transitory computer readable medium of claim 26, wherein the traditional office style includes a first ratio of single-user workspace to common space, the progressive office style includes a second ratio of single-use workspace to common space, and the modern office style includes a third ratio of single-user work space to common space, wherein the first ratio is greater than the second ratio, and the third ratio falls between the first ratio and the second ratio and wherein the selected test fit parameters for office sizes are adjusted based on the selected one of the office styles.

28. The non-transitory computer readable medium of claim 24, wherein the headcount includes at least one of the following: a number of workers or a number of workspaces.

29. The non-transitory computer readable medium of claim 21, wherein the parameters of the property record include space available for lease or rent, gearing ratios, leasing or rental cost per square foot, estimated tax expense per square foot, estimated utilities cost, and a CAD layout of each available unit.

30. The non-transitory computer readable medium of claim 21, wherein the selected test fit parameters further comprise a tenant allowance cost, a specialty budget cost, or a lease or rental rate cost for part or all of the property, wherein the generated leasing cost estimate and the generated construction cost estimate are adjusted based on the tenant allowance cost, the specialty budget cost, or the lease or rental rate cost for part or all of the property.
